(19) United States
(12) Patent Application Publication
(10) Pub. No.: US 2021/0081805 A1
(43) Pub. Date: Mar. 18, 2021

(54) MODEL LEARNING APPARATUS, MODEL LEARNING METHOD, AND PROGRAM

(71) Applicant: NIPPON TELEGRAPH AND TELEPHONE CORPORATION, Tokyo (JP)

(72) Inventors: Yuta KAWACHI, Tokyo (JP); Yuma KOIZUMI, Tokyo (JP); Noboru HARADA, Tokyo (JP)

(73) Assignee: NIPPON TELEGRAPH AND TELEPHONE CORPORATION, Tokyo (JP)

(21) Appl. No.: 16/970,330

(22) PCT Filed: Feb. 14, 2019
(86) PCT No.: PCT/JP2019/005230

§ 371 Date: Aug. 14, 2020

(30) Foreign Application Priority Data
Feb. 16, 2018 (JP) 2018-025607

(51) Int. Cl. G06N 3/08; G06N 3/04

(52) U.S. Cl. CPC G06N 3/088; G06N 3/0454

(57) ABSTRACT

The present disclosure relates to a method of machine learning regardless of the number of dimensions of the samples. The method provides model learning of a variational auto-encoder that uses AUC optimization criteria. The method includes learning parameters θ\hat{ } and φ\hat{ } of the a variational auto-encoder. The variational auto-encoder includes an encoder for constructing a latent variable from an observed variable and a decoder for reconstructing the observed variable. The method uses learning data set defined using based on normal data generated from sounds observed during normal operation and abnormal data generated from sounds observed during abnormal operation. The AUC value is based in part on a reconstruction probability. Incorporating aspects of the reconstruction error into the AUC value prevents the variational auto-encoder from divergence of the abnormality degree regarding the abnormal data.

### CROSS-REFERENCE TO RELATED APPLICATIONS

This application is a U.S. 371 application of International Patent Application No. PCT/JP2019/005230, filed on 14 Feb. 2019, which application claims priority to and the benefit of JP Application No. 2018-025607, filed on 16 Feb. 2018, the disclosures of which are hereby incorporated herein by reference in their entireties.

### TECHNICAL FIELD

The present invention relates to a model learning technique for learning a model used to detect abnormality from observed data, such as to detect failure from operation sound of a machine.

### BACKGROUND ART

For example, it is important in terms of continuity of services to find failure of a machine before the failure occurs or to quickly find it after the failure occurs. As a method for saving labor for this, there is a technical field referred to as abnormality detection for finding “abnormality”, which is deviation from the normal state, from data acquired using a sensor (hereinafter referred to as sensor data) by using an electric circuit or a program. In particular, abnormality detection using a sensor for converting sound into an electric signal such as a microphone is called abnormal sound detection. Abnormality detection may be similarly performed for any abnormality detection domain which targets any sensor data other than sound such as temperature, pressure, or displacement or traffic data such as a network communication amount, for example.

In the field of abnormality detection, an AUC (area under the receiver operating characteristic curve) is known as a representative measure indicative of the level of accuracy of abnormality detection. There is a technique referred to as AUC optimization which is an approach for optimizing the AUC in direct supervised learning (Non-Patent Literature 1 and Non-Patent Literature 2).

There is a technique which applies a generative model referred to as VAE (variational autoencoder) to abnormality detection (Non-Patent Literature 3).

### CITATION LIST

### Non-Patent Literature

Non-Patent Literature 1: Akinori Fujino and Naonori Ueda, “A Semi-Supervised AUC Optimization Method with Generative Models”, 2016 IEEE 16th International Conference on Data Mining (ICDM), IEEE, pp. 883-888, 2016.
Non-Patent Literature 2: Alan Herschtal and Bhavani Raskutti, “Optimising area under the ROC curve using gradient descent”, ICML '04, Proceedings of the twenty-first international conference on Machine learning, ACM, 2004.
Non-Patent Literature 3: Jinwon An and Sungzoon Cho, “Variational Autoencoder based Abnormality Detection using Reconstruction Probability”, Internet <URL: http://dm.snu.ac.kr/static/docs/TR/SNUDM-TR-2015-03.pdf>, 2015.

### SUMMARY OF THE INVENTION

### Technical Problem

An AUC optimization criterion has an advantage in that an optimal model may directly be learned for an abnormality detection task. On the other hand, model learning by a variational autoencoder in related art in which unsupervised learning is performed using only normal data has a disadvantage that the expressive power of a learned model is high but an abnormality detection evaluation criterion is not necessarily optimized.

Then, it is possible to apply the AUC optimization criterion to model learning by a variational autoencoder, but in application, the definition of “abnormality degree” that represents the degree of abnormality of a sample (observed data) becomes important. A reconstruction probability is often used for definition of the abnormality degree. However, there is a problem that because the reconstruction probability defines the abnormality degree depending on the dimensionality that the sample has, “the curse of dimensionality” due to the magnitude of dimension may not be avoided (Reference Non-Patent Literature 1).
(Reference Non-Patent Literature 1: Arthur Zimek, Erich Schubert, and Hans-Peter Kriegel, “A survey on unsupervised outlier detection in high-dimensional numerical data”, Statistical Analysis and Data Mining, Vol. 5, Issue 5, pp. 363-387, 2012.)

That is, in a case where the dimensionality of the sample is high, it is not easy to perform model learning by the variational autoencoder using the AUC optimization criterion.

Accordingly, one object of the present invention is to provide a model learning technique that enables model learning by a variational autoencoder using an AUC optimization criterion regardless of the dimensionality of a sample.

### Means for Solving the Problem

One aspect of the present invention provides a model learning device including a model learning unit that learns parameters θ″ and ϕ\hat{ } of a model of a variational autoencoder formed with an encoder q(z|x; ϕ) which has a parameter ϕ and is for constructing a latent variable z from an observed variable x and a decoder p(x|z; θ) which has a parameter θ and is for reconstructing the observed variable x from the latent variable z by using a learning data set based on a criterion which uses a prescribed AUC value, the learning data set being defined using normal data generated from sound observed in a normal state and abnormal data generated from sound observed in an abnormal state, in which the AUC value is defined using a measure (hereinafter referred to as abnormality degree) for measuring a difference between the encoder q(z|x; ϕ) and a prior distribution p(z) about the latent variable z and a reconstruction probability.

One aspect of the present invention provides a model learning device including a model learning unit that learns parameters θ″ and ϕ of a model of a variational autoencoder formed with an encoder q(z|x; ϕ) which has a parameter ϕ and is for constructing a latent variable z from an observed variable x and a decoder p(x|z; θ) which has a parameter θ and is for reconstructing the observed variable x from the latent variable z by using a learning data set based on a criterion which uses a prescribed AUC value, the learning data set being defined using normal data generated from sound observed in a normal state and abnormal data generated from sound observed in an abnormal state, in which the AUC value is defined using a measure (hereinafter referred to as abnormality degree) for measuring a difference between the encoder q(z|x; ϕ) and a prior distribution p(z) about the latent variable z with respect to the normal data or a prior distribution p⁻ (z) about the latent variable z with respect to the abnormal data and a reconstruction probability, the prior distribution p(z) is a distribution that is dense at an origin and a periphery of the origin, and the prior distribution p⁻ (z) is distribution that is sparse at the origin and the periphery of the origin.

One aspect of the present invention provides a model learning device including a model learning unit that learns parameters θ\hat{ } and ϕ\hat{ } of a model of a variational autoencoder formed with an encoder q(z|x; ϕ) which has a parameter ϕ and is for constructing a latent variable z from an observed variable x and a decoder p(x|z; θ) which has a parameter θ and is for reconstructing the observed variable x from the latent variable z by using a learning data set based on a criterion which uses a prescribed AUC value, the learning data set being defined using normal data generated from data observed in a normal state and abnormal data generated from data observed in an abnormal state, in which the AUC value is defined using a measure (hereinafter referred to as abnormality degree) for measuring a difference between the encoder q(z|x; ϕ) and a prior distribution p(z) about the latent variable z and a reconstruction probability.

### Effects of the Invention

The invention enables model learning by a variational autoencoder using an AUC optimization criterion regardless of the dimensionality of a sample.

### BRIEF DESCRIPTION OF DRAWINGS

FIG. 1 is a diagram that illustrates the appearance of a Heaviside step function and its approximate functions.

FIG. 2 is a block diagram that illustrates an example configuration of model learning devices 100 and 101.

FIG. 3 is a flowchart that illustrates an example operation of the model learning devices 100 and 101.

FIG. 4 is a block diagram that illustrates an example configuration of an abnormality detection device 200.

FIG. 5 is a flowchart that illustrates an example operation of the abnormality detection device 200.

### DESCRIPTION OF EMBODIMENTS

An embodiment of the present invention will hereinafter be described in detail. Note that the same reference numerals are provided to constituent units that have the same functions, and descriptions thereof will not be made.

In the embodiment of the present invention, an abnormality degree that uses a latent variable which may have any dimension in accordance with the setting by a user is defined, and a problem with the dimensionality of data is thereby solved. However, when an AUC optimization criterion is directly applied using this abnormality degree, formulation is performed such that lowering of the abnormality degree with respect to normal data is restricted but elevation of the abnormality degree with respect to abnormal data is less restricted, and the abnormality degree with respect to the abnormal data diverges. When learning is performed in such a manner that the abnormality degree diverges, the absolute values of parameters become large, and inconvenience such as instability of numerical calculation may occur. Accordingly, a model learning method by a variational autoencoder is suggested in which model learning is performed such that a reconstruction probability is incorporated in the definition of an AUC value and autoregression is simultaneously performed and inhibition of divergence of the abnormality degree with respect to the abnormal data thereby becomes possible.

First, the technical background of the embodiment of the present invention will be described.

### TECHNICAL BACKGROUND

Unless otherwise specified, lower-case variables appearing in the following description shall represent scalars or (vertical) vectors.

In order to learn a model having a parameter ψ, a set of abnormal data X⁺={xᵢ⁺|i∈[1, N⁺]} and a set of normal data X⁻={xⱼ⁻|j∈[1, . . . , N⁻]} are prepared. An element of each set corresponds to one sample of a feature amount vector or the like.

A direct product set X={(xᵢ⁺, xⱼ⁻)|i∈[1, . . . , N⁺], j∈[1, . . . , N⁻]} of the abnormal data set X⁺ and the normal data set X⁻ whose number of elements is N=N⁺×N⁻ is set as a learning data set. In this case, an (empirical) AUC value is given by the following expression.

$$\begin{matrix}[ Formula 1 ] & \\ AUC [ X , ψ ] = \frac{1}{N} {\sum }_{i , j} H ( I ( {x}_{i}^{+} ; ψ ) - I ( {x}_{j}^{-} ; ψ ) ) & ( 1 )\end{matrix}$$

Note that a function H(x) is a Heaviside step function. That is, the function H(x) is a function which returns 1 when the value of an argument x is greater than 0 and returns 0 when it is less than 0. A function I(x; ψ) is a function which has a parameter ψ and returns an abnormality degree corresponding to the argument x. Note that the value of the function I(x; ψ) corresponding to x is a scalar value and may be referred to as abnormality degree of x.

Expression (1) represents that a model is preferable in which for any pair of abnormal data and normal data, the abnormality degree of the abnormal data is greater than the abnormality degree of the normal data. The value of Expression (1) becomes the maximum in a case where the abnormality degree of the abnormal data is greater than the abnormality degree of the normal data for all pairs, and then the value becomes 1. A criterion for obtaining the parameter ψ which maximizes (that is, optimizes) this AUC value is the AUC optimization criterion.

Meanwhile, the variational autoencoder is fundamentally a (autoregressive) generative model in which learning is performed by unsupervised learning. When the variational autoencoder is used for abnormality detection, it is a common practice to perform learning using only the normal data and to perform abnormality detection using a suitable abnormality degree defined by a reconstruction error, a reconstruction probability, a variational lower bound, and so forth.

However, because the above abnormality degree defined using the reconstruction error and so forth includes a regression error in any case, the curse of dimensionality may not be avoided in a case where the dimensionality of a sample is high. That is, circumstances in which only similar abnormality degrees are output occur, regardless of normal or abnormal, due to concentration on the sphere. A usual approach to this problem is lowering the dimensionality.

The variational autoencoder deals with a latent variable z for which any dimensionality of 1 or greater may be set in addition to an observed variable x. Thus, it is possible that an encoder that has a parameter ϕ and is for constructing the latent variable z from the observed variable x, that is, the posterior probability distribution q(z|x; ϕ) of the latent variable z is used to convert the observed variable x into the latent variable z and learning is performed by the AUC optimization criterion that uses the results of the conversion.

A marginal likelihood maximization criterion for the variational autoencoder by a usual unsupervised learning is substituted using a maximization criterion of a variational lower bound L (θ, ϕ; X⁻) of the following expression.

$$\begin{matrix} [ Formula 2 ] & \\ L ( θ , φ ; {X}^{-} ) ≅ {\sum }_{j} \{ \frac{1}{L} {\sum }_{l ∈ \{ 1 , … , L \}} log p ( {x}_{j}^{-} \vert {z}^{( l )} ; θ ) - KL [ q ( z \vert {x}_{j}^{-} ; φ ) ‖ p ( z ) ] \} \\ {z}^{( l )} \sim q ( {z}^{( l )} \vert {x}_{j}^{-} ; φ ) , l ∈ [ 1 , … , L ] & ( 2 )\end{matrix}$$

However, p(x|z; θ) is a decoder that has a parameter θ and is for reconstructing the observed variable x from the latent variable Z, that is, the posterior probability distribution of the observed variable x. Further, p(z) is a prior distribution about the latent variable z. For p(z), the Gaussian distribution in which the average is 0 and the vector variance is an identity matrix is usually used.

KL divergence KL[q(z|x; ϕ)∥p(z)] that represents the distance from the prior distribution p(z) of the latent variable z in the above maximization criterion is used to define the abnormality degree I_{KL}(x; ϕ) by the following expression.

[Formula 3]

I_{LL}(x;ϕ)=KL[q(z|x;ϕ)∥p(z)] (3)

The abnormality degree I_{KL}(x; ϕ) indicates that abnormality is higher as its value is greater and normality is higher as its value is smaller. Because it is possible to set any dimension for the latent variable z, it is possible to reduce the dimensionality by defining the abnormality degree I_{KL}(x; ϕ) by Expression (3).

However, the AUC value of Expression (1) that uses the abnormality degree I_{KL}(x; ϕ) does not include the reconstruction probability. Thus, depending on the method for approximating the Heaviside step function, which will be described later, the approximation value of Expression (1) may be raised limitlessly by raising the abnormality degree I_{KL}(x⁺; ϕ) with respect to the abnormal data, and the abnormality degree diverges. This problem is solved by inclusion of the reconstruction probability that works for retaining the feature of the observed variable x. Accordingly, it becomes difficult to make the abnormality degree an extremely large value, and it thereby becomes possible to inhibit divergence of the abnormality degree with respect to the abnormal data.

Then, a case is considered where Expression (1) is redefined using a reconstruction probability RP(Z={z⁽¹⁾}; θ) of the following expression.

$$\begin{matrix}[ Formula 4 ] & \\ RP ( Z = \{ {z}^{( l )} \} ; θ ) = \frac{1}{L} {\sum }_{l ∈ \{ 1 , … , L \}} log p ( x \vert {z}^{( l )} ; θ ) \\ {z}^{( l )} \sim q ( {z}^{( l )} \vert x ; φ ) , l ∈ [ 1 , … , L ] & ( 4 )\end{matrix}$$

Specifically, an AUC value in which the reconstruction probability RP(Z={z^{(l)}}; θ) is combined into a parameter set ψ={θ, ϕ) is defined by the following expression.

$$\begin{matrix} [ Formula 5 ] & \\ AUC [ X , θ , φ ] = \frac{1}{N} {\sum }_{i , j} H ( RP ( {Z}_{i}^{+} ; θ ) + RP ( {Z}_{j}^{-} ; θ ) + {I}_{KL} ( {x}_{i}^{+} ; φ ) - {I}_{KL} ( {x}_{j}^{-} ; φ ) ) \\ RP ( {Z}_{i}^{+} ; θ ) = \frac{1}{L} {\sum }_{l ∈ \{ 1 , … , L \}} log p ( {x}_{i}^{+} \vert {z}^{( l )} ; θ ) \\ {z}^{( l )} \sim q ( {z}^{( l )} \vert {x}_{i}^{+} ; φ ) , l ∈ [ 1 , … , L ] \\ RP ( {Z}_{j}^{-} ; θ ) = \frac{1}{L} {\sum }_{l ∈ \{ 1 , … , L \}} log p ( {x}_{j}^{-} \vert {z}^{( l )} ; θ ) \\ {z}^{( l )} \sim q ( {z}^{( l )} \vert {x}_{j}^{-} ; φ ) , l ∈ [ 1 , … , L ] & ( 5 )\end{matrix}$$

Alternatively, the AUC value is defined by the following expression in which the reconstruction probability RP(Z={z^{(l)}}; θ) is placed outside the Heaviside step function.

$$\begin{matrix} [ Formula 6 ] & \\ AUC [ X , θ , φ ] = \frac{1}{N} {\sum }_{i , j} \{ RP ( {Z}_{i}^{+} ; θ ) + RP ( {Z}_{j}^{-} ; θ ) + H ( {I}_{KL} ( {x}_{i}^{+} ; φ ) - {I}_{KL} ( {x}_{j}^{-} ; φ ) ) \} \\ RP ( {Z}_{i}^{+} ; θ ) = \frac{1}{L} {\sum }_{l ∈ \{ 1 , … , L \}} log p ( {x}_{i}^{+} \vert {z}^{( l )} ; θ ) \\ {z}^{( l )} \sim q ( {z}^{( l )} \vert {x}_{i}^{+} ; φ ) , l ∈ [ 1 , … , L ] \\ RP ( {Z}_{j}^{-} ; θ ) = \frac{1}{L} {\sum }_{l ∈ \{ 1 , … , L \}} log p ( {x}_{j}^{-} \vert {z}^{( l )} ; θ ) \\ {z}^{( l )} \sim q ( {z}^{( l )} \vert {x}_{j}^{-} ; φ ) , l ∈ [ 1 , … , L ] & ( 6 )\end{matrix}$$

When the AUC values of Expression (5) and Expression (6) are used, reconstruction of the observed variable and AUC optimization may simultaneously be performed. Further, compared to Expression (5), Expression (6) does not have restriction of the maximum value by the Heaviside step function and is thus in a form which gives priority to restriction of reconstruction.

A contribution degree of each term of Expression (5) and Expression (6) may be changed using a linear coupling constant. In particular, the linear coupling constant about reconstruction probability terms is set as 0 (that is, the contribution of the reconstruction probability terms is set as 0), learning is discontinued at any time point, and divergence of the abnormality degree with respect to the abnormal data may thereby be prevented. The balance among the contribution degree of each term of Expression (5) and Expression (6) may be selected such that the AUC value becomes high in an abnormality detection target domain, for example, by actually evaluating the relationship between the extent of restriction of reconstruction and the AUC value in the abnormality detection target domain.

A term I_{KL}(xᵢ⁺; ϕ)−I_{KL}(xⱼ⁻; ϕ) about the difference between the abnormality degrees becomes the following expression in a case where the Gaussian distribution is used as a prior distribution p(z) in which the average is 0 and the vector variance is an identity matrix.

$$\begin{matrix} [ Formula 7 ] & \\ {I}_{KL} ( {x}_{i}^{+} ; φ ) - {I}_{KL} ( {x}_{j}^{-} ; φ ) = log \frac{{σ}_{j}^{-}}{{σ}_{i}^{+}} + \frac{1}{2} ( {σ}_{i}^{+} \cdot {σ}_{i}^{+} + {μ}_{i}^{+} \cdot {μ}_{i}^{+} - {σ}_{j}^{-} \cdot {σ}_{j}^{-} - {μ}_{j}^{-} \cdot {μ}_{j}^{-} ) & ( 7 )\end{matrix}$$

However, μᵢ⁺ and σᵢ⁺ and μⱼ⁻ and σⱼ⁻ are parameters of an encoder q(z|x; ϕ) that corresponds to abnormal data xᵢ⁺ and normal data xⱼ⁻.

In a case where the latent variable z is multi-dimensional, the sum of terms about the difference between the abnormality degrees in each dimension may be obtained.

It may be understood that the AUC value is invariable in a case where the maximum value of the reconstruction probability RP(Z={z^{(l)}}; θ) becomes 0 (a case where the reconstruction may perfectly be performed). That is, the AUC values of Expression (5) and Expression (6) agree with (empirical) AUC values. For example, this applies to a case where the maximum value of a reconstruction probability density p(x|z^{(l)}; θ) becomes 1. For the reconstruction probability term, any function that represents a regression problem, a discriminant problem, or the like may be used in accordance with kinds of vectors of the observed variable such as a continuous vector and a discrete vector, for example.

Expression (5) and Expression (6) are differentiated with respect to the parameters, the gradients are obtained, a suitable gradient method is used, and it thereby becomes possible to derive an optimal parameter ψ\hat{=}{θ\hat{ }, ϕ\hat{ }}. However, because the Heaviside step function H(x) is indifferentiable at the origin, the derivation may not directly succeed.

In related art, the AUC optimization is performed by approximating the Heaviside step function H(x) using a continuous function which is differentiable or subdifferentiable. Here, because the KL divergence may be made larger limitlessly, it may be understood that restriction has to be provided for the maximum value of the Heaviside step function H(x). Actually, the minimum value and the maximum value of the Heaviside step function are respectively 0 and 1, and restriction is set not only for the maximum value but also for the minimum value. However, in terms of a desire to make penalty large for a case where the reversal of the abnormality degrees between normal and abnormal is considerable (“abnormality degree reversal” occurs), it is more desirable that restriction be not provided for the minimum value. Various function approximation methods for the AUC optimization are known (for example, Reference Non-Patent Literature 2, Reference Non-Patent Literature 3, and Reference Non-Patent Literature 4). In the following, approximation methods that use a ramp function and a softplus function will be described.
(Reference Non-Patent Literature 2: Charanpal Dhanjal, Romaric Gaudel and Stephan Clemencon, “AUC Optimisation and Collaborative Filtering”, arXiv preprint, arXiv: 1508.06091, 2015.)
(Reference Non-Patent Literature 3: Stijn Vanderlooy and Eyke Hullermeier, “A critical analysis of variants of the AUC”, Machine Learning, Vol. 72, Issue 3, pp. 247-262, 2008.)
(Reference Non-Patent Literature 4: Steffen Rendle, Christoph Freudenthaler, Zeno Gantner and Lars Schmidt-Thieme, “BPR: Bayesian personalized ranking from implicit feedback”, UAI '09, Proceedings of the Twenty-Fifth Conference on Uncertainty in Artificial Intelligence, pp. 452-461, 2009.)

A ramp function (its variant) ramp′(x) that restricts the maximum value is given by the following expression.

$$\begin{matrix}[ Formula 8 ] & \\ {ramp}^{′} ( x ) = \{ \begin{matrix}1 & ( x > 0 ) \\ x + 1 & ( x \leq 0 )\end{matrix} & ( 8 )\end{matrix}$$

A softplus function (its variant) softplus′(x) is given by the following expression.

[Formula 9]

softplus′(x)=1−ln(1+exp(−x)) (9)

The function in Expression (8) is a function for linearly giving a cost when the abnormality degrees are reversed, and the function in Expression (9) is a differentiable approximate function.

The AUC value of Expression (5) that uses the softplus function (Expression (9)) becomes the following expression.

$$\begin{matrix} [ Formula 10 ] & \\ AUC [ X , θ , φ ] = \frac{1}{N} {\sum }_{i , j} \{ 1 - ln ( 1 + exp ( - RP ( {Z}_{i}^{+} ; θ ) - RP ( {Z}_{j}^{-} ; θ ) - {I}_{KL} ( {x}_{i}^{+} ; φ ) + {I}_{KL} ( {x}_{j}^{-} ; φ ) ) ) \} & ( 10 )\end{matrix}$$

When the softplus function is used and it may be considered that the value of an argument is sufficiently large, that is, an abnormality determination succeeds, the softplus function returns a value close to 1, similarly to the Heaviside step function, a standard sigmoid function, and the ramp function. In a case where the argument is sufficiently small, that is, extreme abnormality degree reversal occurs, the softplus function may return a value proportional to the extent of the abnormality degree reversal as the penalty, similarly to the ramp function.

In the standard sigmoid function, because the slope of the function is present even in a case where the abnormality detection succeeds, an effect of expanding a margin between the abnormality degree of the abnormal data and the abnormality degree of the normal data, which is not present in a strict AUC, is present. The magnitude of the margin between the abnormality degrees is not measured in the strict AUC but is an important measure in an abnormality detection task. The abnormality detection task is more robust against disturbance as the margin is greater. Because a slope is present in the positive region also in Expression (10) as an approximation that uses the softplus function, the above effect that the standard sigmoid function has may be expected.

It is known that a function approximation may be designed such that a margin with any magnitude is obtained by shifting the whole function to the right and mistakes in the abnormality detection are tolerated to a certain extent by shifting the whole function to the left. Thus, the sum of constants may be used for an argument in any approximate function.

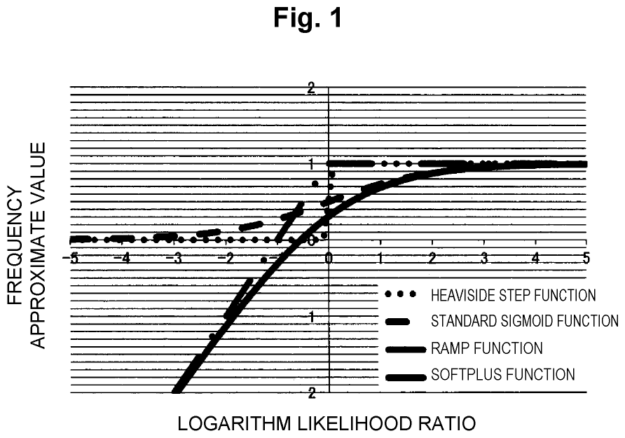

FIG. 1 illustrates the appearance of the Heaviside step function and its approximate functions (the standard sigmoid function, the ramp function, and the softplus function). In FIG. 1, with 0 being the boundary, the positive region may be seen as a case where the abnormality detection succeeds with respect to a pair of normal data and abnormal data, and the negative region may be seen as a case where the abnormality detection fails.

When an approximate function of the Heaviside step function is used, the parameter ψ may be optimized by a gradient method or the like so as to optimize the AUC value (approximate AUC value) that uses those approximate functions such as Expression (10).

The approximate AUC value optimization criterion partially includes the marginal likelihood maximization criterion for the variational autoencoder by an unsupervised learning in related art. Thus, a stable operation may be expected. A detailed description will be made. In an approximation that uses the ramp function or the softplus function, in a case where the extent of the abnormality degree reversal is large, that is, at a negative limit, the Heaviside step function H(x) approximates x+1. Thus, the approximate AUC value becomes the following expression.

$$\begin{matrix} [ Formula 11 ] & \\ AUC [ X , θ , φ ] ≅ \frac{1}{N} {\sum }_{i , j} \{ RP ( {Z}_{i}^{+} ; θ ) + {I}_{KL} ( {x}_{i}^{+} ; φ ) + RP ( {Z}_{j}^{-} ; θ ) - {I}_{KL} ( {x}_{j}^{-} ; φ ) \} + 1 & ( 11 )\end{matrix}$$

Here, a term RP(Zⱼ⁻; θ)−I_{KL}(xⱼ⁻; ϕ) in Expression (11) agrees with the marginal likelihood of the variational autoencoder by unsupervised learning that uses the normal data. Further, as for the abnormal data, the sign of the KL divergence term is reversed from usual marginal likelihood. That is, in a case where the extent of the abnormality degree reversal is large such as an early stage of learning in which abnormality detection performance is low, similar learning to a method in related art is performed for the normal data. On the other hand, for the abnormal data, while reconstruction is performed, learning is performed in the direction to separate a posterior distribution q(z|x; ϕ) from the prior distribution p(z) of the latent variable z. In a case where it is strongly considered that learning sufficiently progresses and the abnormality determination succeeds, the approximate function of the Heaviside step function H(x) becomes 1 (identity function), the gradient in the direction to separate the posterior distribution q(z|x; ϕ) about the abnormal data becomes low, and an infinite increase of I_{KL}(x; ϕ) as the abnormality degree is spontaneously prevented.

### First Embodiment

(Model Learning Device 100)

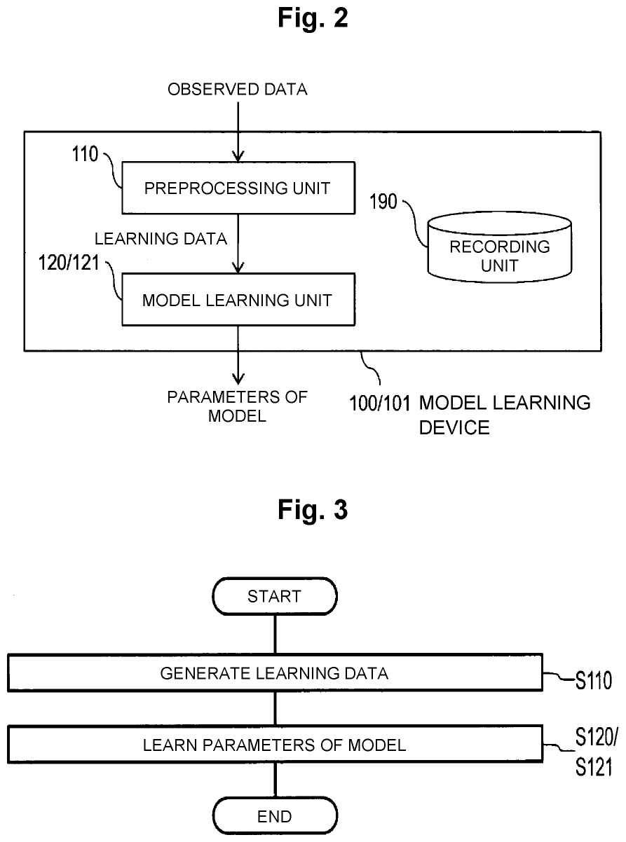

In the following, a model learning device 100 will be described with reference to FIG. 2 and FIG. 3. FIG. 2 is a block diagram that illustrates a configuration of the model learning device 100. FIG. 3 is a flowchart that illustrates an operation of the model learning device 100. As illustrated in FIG. 2, the model learning device 100 includes a preprocessing unit 110, a model learning unit 120, and a recording unit 190. The recording unit 190 is a constituent unit which appropriately records information necessary for processing in the model learning device 100.

In the following, the operation of the model learning device 100 will be described in accordance with FIG. 3.

In S110, the preprocessing unit 110 generates learning data from observed data. In a case where abnormal sound detection is targeted, the observed data is sound observed in the normal state or sound observed in the abnormal state, such as a sound waveform of normal operation sound or abnormal operation sound of a machine. Thus, whatever field is targeted for abnormality detection, the observed data includes both of data observed in the normal state and data observed in the abnormal state.

The learning data generated from the observed data is generally represented as a vector. In a case where abnormal sound detection is targeted, the observed data, that is, sound observed in the normal state or sound observed in the abnormal state is A/D (analog-to-digital)-converted at a suitable sampling frequency to generate quantized waveform data. The thus-quantized waveform data may be directly used to regard data in which one-dimensional values are arranged in time series as the learning data; data subjected to feature extraction processing for extension into multiple dimensions using concatenation of multiple samples, discrete Fourier transform, filter bank processing, or the like may be used as the learning data; or data subjected to processing such as normalization of the range of possible values by calculating the average and variance of data may be used as the learning data. In a case where a field other than abnormal sound detection is targeted, it is sufficient to perform similar processing for a continuous amount such as temperature and humidity or a current value for example, and it is sufficient to form a feature vector using numeric values or 1-of-K representation and perform similar processing for a discrete amount such as a frequency or text (for example, characters, word strings, and so forth), for example.

Note that learning data generated from observed data in the normal state is referred to as normal data, and learning data generated from observed data in the abnormal state is referred to as abnormal data. The abnormal data set is denoted as X⁺={xᵢ⁺|i∈[1, . . . , N]}, and the normal data set is denoted as X⁻={xⱼ⁻ |j∈[1, . . . , N⁻]}. As described in <Technical Background>, a direct product set X={(xᵢ⁺, xⱼ⁻)|i∈[1, . . . , N⁺], j∈[1, . . . , N⁻]} of the abnormal data set X⁺ and the normal data set X⁻ is referred to as a learning data set. The learning data set is a set defined using the normal data and the abnormal data.

In S120, the model learning unit 120 uses the learning data set that is defined using the normal data and abnormal data generated in S110 and learns parameters θ\hat{ } and ϕ\hat{ } of a model of a variational autoencoder formed with following (1) and (2) based on a criterion that uses a prescribed AUC value.

(1) An encoder q(z|x; ϕ) that has a parameter ϕ and is for constructing the latent variable z from the observed variable x.
(2) A decoder p(x|z; θ) that has a parameter θ and is for reconstructing the observed variable x from the latent variable z.

Here, the AUC value is a value that is defined using a measure (hereinafter referred to as abnormality degree) for measuring the difference between the encoder q(z|x; ϕ) and the prior distribution p(z) about the latent variable z and a reconstruction probability defined as the average of values resulting from assignment of the decoder p(x|z; θ) to a prescribed function. The measure for measuring the difference between the encoder q(z|x; ϕ) and the prior distribution p(z) is defined as the Kullback-Leibler divergence with respect to the prior distribution p(z) of the encoder q(z|x; ϕ) such as Expression (3), for example. The reconstruction probability is defined as Expression (4) in a case where a logarithm function is used as a function to which the decoder p(x|z; θ) is assigned, for example. Further, the AUC value is calculated as Expression (5) or Expression (6), for example. That is, the AUC value is a value that is defined using the sum of a value calculated from the abnormality degree and a value calculated from the reconstruction probability.

When the model learning unit 120 learns the parameters θ\hat{ } and ϕ\hat{ } using the AUC value, the optimization criterion is used for learning. Here, in order to obtain the parameters θ\hat{ } and ϕ\hat{ } as the optimal values of the parameters θ and ϕ, any optimization method may be used. For example, in a case where a stochastic gradient method is used, a learning data set that has the direct products between the abnormal data and the normal data as elements is decomposed into mini-batch sets of any unit, and a mini-batch gradient method may be used. The above learning may be started for a usual unsupervised variational autoencoder while the parameters θ and ϕ of a model learned with the marginal likelihood maximization criterion are set as initial values.

(Abnormality Detection Device 200)

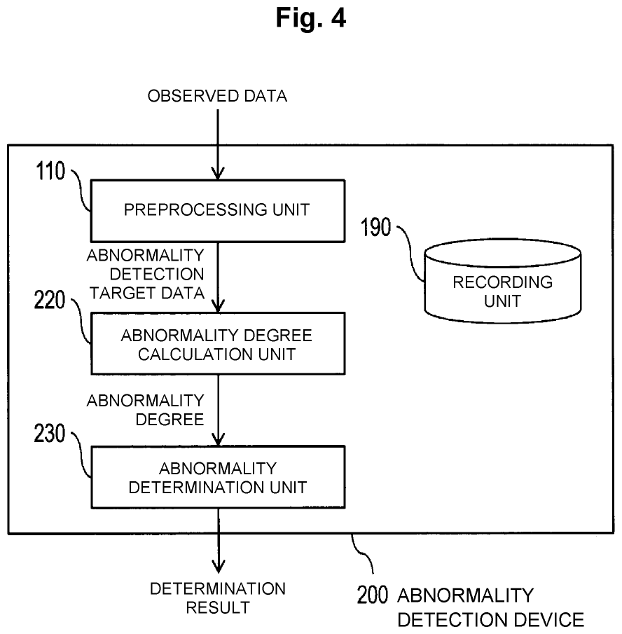

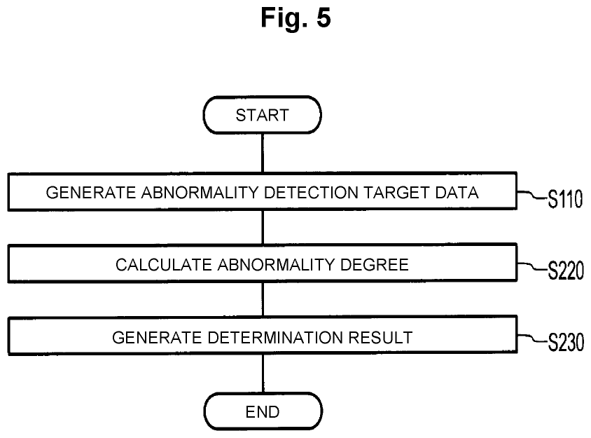

In the following, the abnormality detection device 200 will be described with reference to FIG. 4 and FIG. 5. FIG. 4 is a block diagram that illustrates a configuration of an abnormality detection device 200. FIG. 5 is a flowchart that illustrates an operation of the abnormality detection device 200. As illustrated in FIG. 4, the abnormality detection device 200 includes the preprocessing unit 110, an abnormality degree calculation unit 220, an abnormality determination unit 230, and the recording unit 190. The recording unit 190 is a constituent unit which appropriately records information necessary for processing in the abnormality detection device 200. For example, the parameters θ\hat{ } and ϕ\hat{ } generated by the model learning device 100 is recorded in advance.

In the following, the operation of the abnormality detection device 200 will be described in accordance with FIG. 5.

In S110, the preprocessing unit 110 generates abnormality detection target data from observed data targeted for abnormality detection. Specifically, abnormality detection target data x is generated in the same manner as when the preprocessing unit 110 of the model learning device 100 generates learning data.

In S220, the abnormality degree calculation unit 220 calculates an abnormality degree from the abnormality detection target data x generated in S110 using the parameters recorded in the recording unit 190. For example, the abnormality degree I(x) may be defined as I(x)=I_{KL}(x; ϕ\hat{ }) by Expression (3). An amount that results from combination such as addition between I_{KL}(x; ϕ\hat{ }) and an amount calculated using the reconstruction probability or the reconstruction error may be set as the abnormality degree. In addition, the variational lower bound such as Expression (2) may be set as the abnormality degree. That is, the abnormality degree used in the abnormality detection device 200 does not have to be the same as the abnormality degree used in the model learning device 100.

In S230, the abnormality determination unit 230 generates a determination result that indicates whether or not the observed data targeted for abnormality detection, which is an input, is abnormal based on the abnormality degree calculated in S220. For example, by using a threshold value that is in advance determined, a determination result that indicates abnormality is generated in a case where the abnormality degree is the threshold value or greater (or greater than the threshold value).

In a case where two or more models (parameters) that are capable of being used by the abnormality detection device 200 are present, the user may determine or select which model is used. As selection methods, the following quantitative method and qualitative method are present.

<Quantitative Method>

An evaluation set which has a similar tendency to a target of abnormality detection (which corresponds to the learning data set) is prepared, the performance of each of the models is assessed in accordance with the magnitude of an original empirical AUC value or approximate AUC value calculated for each of the models.

<Qualitative Method>

In a case where model learning is performed by setting the dimensions of the latent variable z as 2 or model learning is performed by setting the dimensions of the latent variable z as 3 or higher, the dimensions of the latent variable z are set as 2 by setting the dimensions as 2 by a dimensionality reduction algorithm or the like. In this case, a two-dimensional latent variable space is divided by grids, the sample is reconstructed with respect to the latent variable by the decoder and is visualized. This method is capable of reconstruction regardless of distinction of the normal data and the abnormal data. Thus, in a case where learning succeeds (the precision of the model is high), the normal data is distributed around the origin, and the abnormal data is distributed away from the origin. The extent of success of learning by each of the models may be understood by visually checking the distribution.

Further, it is possible to make an assessment by simply checking which position in two-dimensional coordinates the input sample moves to using only the encoder.

Alternatively, similarly to the above, the evaluation set is prepared, a projection onto the latent variable space output by the encoder is generated for each of the models. The projection, the projections of known normal and abnormal samples, and visualized results of data reconstructed from those projections by the decoder are displayed on a screen and compared. Accordingly, the validity of the models is assessed based on knowledge of the user about the abnormality detection target domain, and which model is used for the abnormality detection is selected.

### Modification Example 1

Model learning based on the AUC optimization criterion performs model learning so as to optimize the difference between the abnormality degree for the normal data and the abnormality degree for the abnormal data. Accordingly, for pAUC optimization similar to the AUC optimization (Reference Non-Patent Literature 4) or for another method for optimizing a value (which corresponds to the AUC value) defined using the difference between the abnormality degrees, model learning is possible by performing similar replacement as described in <Technical Background>.
(Reference Non-Patent Literature 4: Harikrishna Narasimhan and Shivani Agarwal, “A structural SVM based approach for optimizing partial AUC”, Proceeding of the 30th International Conference on Machine Learning, pp. 516-524, 2013.)

### Modification Example 2

In the first embodiment, a description is made about the model learning on the assumption that only the prior distribution p(z) about the latent variable z described in <Technical Background> is used. Here, a description will be made about a form in which model learning is performed on the assumption that different prior distributions are provided to the normal data and the abnormal data.

The prior distribution about the latent variable z with respect to the normal data is set as p(z), the prior distribution about the latent variable z with respect to the abnormal data is set as p⁻ (z), and restriction of following (1) and (2) is provided.

(1) The prior distribution p(z) is a distribution that concentrates on the origin in the latent variable space, that is, distribution which is dense at the origin and its periphery.

(2) The prior distribution p⁻ (z) is a distribution that is sparse at the origin and its periphery.

In a case where the dimension of the latent variable z is set as 1, for example, the Gaussian distribution whose average is 0 and variance is 1 may be used as the prior distribution p(z), and for example, the distribution of the following expression may be used as the prior distribution p⁻ (z).

$$\begin{matrix}[ Formula 12 ] & \\ \overline{p} ( z ) = \frac{1}{Y} N ( z ; 0 , {s}^{2} ) ( {max}_{{z}^{′}} N ( {z}^{′} ; 0 , 1 ) - N ( z ; 0 , 1 ) ) & ( 12 )\end{matrix}$$

Note that N(z; 0, s²) is the Gaussian distribution whose average is 0 and variance is s², N(z; 0, 1) is the Gaussian distribution whose average is 0 and variance is 1, and Y is a prescribed constant. Further, s is a hyperparameter whose value is usually experimentally determined.

In a case where the dimensions of the latent variable z are 2 or higher, the Gaussian distribution and the distribution of Expression (12) may be assumed for each dimension.

In the following, a model learning device 101 will be described with reference to FIG. 2 and FIG. 3. FIG. 2 is a block diagram that illustrates a configuration of the model learning device 101. FIG. 3 is a flowchart that illustrates an operation of the model learning device 101. As illustrated in FIG. 2, the model learning device 101 includes the preprocessing unit 110, a model learning unit 121, and the recording unit 190. The recording unit 190 is a constituent unit that appropriately records information necessary for processing in the model learning device 101.

In the following, the operation of the model learning device 101 will be described in accordance with FIG. 3. Here, the model learning unit 121 will be described.

In S121, the model learning unit 121 uses the learning data set that is defined using the normal data and abnormal data generated in S110 and learns parameters θ\hat{ } and ϕ\hat{ } of a model of a variational autoencoder formed with following (1) and (2) based on a criterion that uses a prescribed AUC value.

(1) An encoder q(z|x; ϕ) that has a parameter ϕ and is for constructing the latent variable z from the observed variable x.

(2) A decoder p(x|z; θ) that has a parameter θ and is for reconstructing the observed variable x from the latent variable z.

Here, the AUC value is a value that is defined using a measure (hereinafter referred to as abnormality degree) for measuring the difference between the encoder q(z|x; ϕ) and the prior distribution p(z) or the prior distribution p⁻ (z) and a reconstruction probability defined as the average of values resulting from assignment of the decoder p(x|z; θ) to a prescribed function. The measure for measuring the difference between the encoder q(z|x; ϕ) and the prior distribution p(z) and the measure for measuring the difference between the encoder q(z|x; ϕ) and the prior distribution p⁻ (z) are given by the following expression.

[Formula 13]

I_{KL}(x;ϕ)=KL[q(z|x;ϕ)∥p(z)] (13)

I_{KL}(x;θ)=KL[q(z|x;θ)∥p̅(z)] (13′)

The reconstruction probability is defined by Expression (4) when a logarithm function is used as a function to which the decoder p(x|z; θ) is assigned, for example. The AUC value is calculated as Expression (5) or Expression (6), for example. That is, the AUC value is a value that is defined using the sum of a value calculated from the abnormality degree and a value calculated from the reconstruction probability.

In a case where the model learning unit 121 learns the parameters θ″ and ϕ\hat{ } using the AUC value, learning is performed using the optimization criterion in a similar manner to the model learning unit 120.

The invention of this embodiment enables model learning by a variational autoencoder using AUC optimization criterion regardless of the dimensionality of a sample. Model learning is performed with the AUC optimization criterion that uses the latent variable z of the variational autoencoder, and the curse of dimensionality may thereby be avoided which a method in related art using a regression error or the like is subject to. In this case, the reconstruction probability is incorporated in the AUC value by addition, and it thereby becomes possible to inhibit a divergence phenomenon of the abnormality degree with respect to the abnormal data.

Model learning is performed based on the optimization criterion by the approximate AUC value, model learning in related art that uses the marginal likelihood maximization criterion is thereby partially incorporated, and stable learning may be realized even in a case where many pairs of normal data and abnormal data whose abnormality degrees are reversed are present.

<Supplement>

For example, as a single hardware entity, a device of the present invention has: an input unit to which a keyboard or the like is connectable; an output unit to which a liquid crystal display or the like is connectable; a communication unit to which a communication device (for example, a communication cable) capable of communicating with the outside of the hardware entity is connectable; a CPU (central processing unit, which may be provided with a cache memory, a register, or the like); a RAM or a ROM which is a memory; an external storage device which is a hard disk; and a bus which connects the input unit, the output unit, the communication unit, the CPU, the RAM, the ROM, and the external storage device to each other so that they can exchange data. In addition, as necessary, the hardware entity may be provided with, for example, a device (drive) which may perform reading/writing from/to a recording medium such as a CD-ROM. Physical entities provided with such hardware resources include a general-purpose computer and so forth.

The external storage device of the hardware entity stores a program necessary for realizing the above function, data necessary in processing of this program, and so forth (this is not limited to an external storage device, and the program may be stored in, for example, a ROM which is a read-only storage device). Further, data and so forth obtained by processing of those programs are appropriately stored in the RAM, the external storage device, and so forth.

In the hardware entity, each program stored in the external storage device (or the ROM and so forth) and data necessary for processing of this each program are read to the memory as necessary, and interpretation, execution, and processing are performed by the CPU as appropriate. As a result, the CPU realizes a prescribed function (each constituent element represented as . . . unit, . . . means, or the like as described above).

The present invention is not limited to the above embodiment and may be modified as appropriate within the range not deviating from the spirit of the present invention. The processing described in the above embodiment may be executed not only in time series according to the order described but also parallelly or individually depending on the processing performance of a device executing the processing or as necessary.

As already mentioned, in a case where the processing function in the hardware entity (the device of the present invention) as described in the above embodiment is realized by a computer, processing contents of a function which the hardware entity should have are written in a program. Then, by executing this program on a computer, the processing function in the above hardware entity is realized on the computer.

A program in which those processing contents are written may be recorded in a computer-readable recording medium. The computer-readable recording medium may be any medium such as a magnetic recording device, an optical disc, a magneto-optical recording medium, or a semiconductor memory, for example. Specifically, for example, a hard disk device, a flexible disk, a magnetic tape, or the like may be used as a magnetic recording device; DVD (digital versatile disc), DVD-RAM (random access memory), CD-ROM (compact disc read only memory), CD-R (recordable)/RW (rewritable), or the like as an optical disc; an MO (magneto-optical disc) or the like as a magneto-optical recording medium; and an EEP-ROM (electronically erasable and programmable-read only memory) or the like as a semiconductor memory.

This program is distributed by, for example, selling, handing over, or lending a portable recording medium such as a DVD or a CD-ROM on which the program is recorded. Furthermore, a configuration is possible in which this program is distributed by storing this program in a storage device of a server computer in advance and transferring the program from the server computer to another computer via a network.

For example, a computer which executes such a program first temporarily stores the program recorded on the portable recording medium or the program transferred from the server computer in its own storage device. Then, when executing processing, this computer reads the program stored in its own recording medium and executes processing according to the read program. As another execution form of this program, the computer may read the program directly from the portable recording medium and execute the processing according to the program, and furthermore, each time the program is transferred from the server computer to this computer, the processing according to the received program may be executed sequentially. A configuration is possible in which the above processing is executed by a so-called ASP (application service provider)-type service which does not transfer the program from the server computer to this computer but realizes the processing function only by its execution instruction and acquisition of results. Note that the program in this embodiment shall include information which is provided for processing by an electronic computer and is equivalent to the program (although this is not a direct command for the computer, it is data having property specifying the processing of the computer or the like).

Although, in this embodiment, the hardware entity is configured by executing a prescribed program on a computer, at least part of those processing contents may be realized in a hardware manner.

1.-8. (canceled)

9. A computer-implemented method of model learning for determining likelihood of conditions, the method comprising:
determining, using an encoder, one or more latent values based on a set of observed values and a first parameter value, the set of observed values including normal data and abnormal data as a learning data set;
reconstructing, using a decoder, the set of observed value based on the determined one or more latent values and the second parameter value;
generating an area-under-the-receiver-operating-characteristic-curve (AUC) value based at least on a set of reconstructing probability of the abnormal data;
training, based on the generated AUC value, the first parameter and the second parameter of a machine learning model based on a variational auto encoder.

10. The computer-implemented method of claim 9, the method further comprising:
receiving the normal data based on sound of an object observed in a normal state and the abnormal data based on sound of the object observed in an abnormal state as the learning data for training the machine learning model for determining whether input data deviate from the normal state.

11. The computer-implemented method of claim 9, wherein the variational auto encoder comprises the encoder and the decoder, and wherein the reconstructing probability of the abnormal data relates to a probability of reconstructing abnormal data based on the set of latent values.

12. The computer-implemented method of claim 9, wherein the AUC value is based at least on the reconstruction probability and a difference of a degree of abnormality between the encoder and a prior distribution about the set of latent values.

13. The computer-implemented method of claim 9, the method further comprising:
receiving the normal data relating to network traffic observed in a normal state and the abnormal data relating to the network traffic observed in an abnormal state as the learning data for training the machine learning model for determining whether input data deviates from the normal state.

14. The computer-implemented method of claim 9, wherein the AUC value is an approximate AUC value based on a Heaviside step function, the approximate AUC value at least providing a marginal likelihood maximization for training the variational auto encoder based on unsupervised learning using the normal data.

15. The computer-implemented method of claim 9, the method further comprising:
receiving a set of data for evaluating abnormality;
determining a degree of abnormality based on the received set of data, wherein the degree of abnormality is based on a combination of a reconstruction probability and a reconstruction error; and
determining a status, the status indicating whether the set of observed values indicates abnormality based on a predetermined threshold value.

16. A system for machine learning, the system comprises:
a processor; and
a memory storing computer-executable instructions that when executed by the processor cause the system to:
determine, using an encoder, one or more latent values based on a set of observed values and a first parameter value, the set of observed values including normal data and abnormal data as a learning data set;
reconstruct, using a decoder, the set of observed value based on the determined one or more latent values and the second parameter value;
generate an area-under-the-receiver-operating-characteristic-curve (AUC) value based at least on a set of reconstructing probability of the abnormal data;
train, based on the generated AUC value, the first parameter and the second parameter of a machine learning model based on a variational auto encoder.

17. The system of claim 16, the computer-executable instructions when executed further causing the system to:
receive the normal data based on sound of an object observed in a normal state and the abnormal data based on sound of the object observed in an abnormal state as the learning data for training the machine learning model for determining whether input data deviate from the normal state.

18. The system of claim 16, wherein the variational auto encoder comprises the encoder and the decoder, and wherein the reconstructing probability of the abnormal data relates to a probability of reconstructing abnormal data based on the set of latent values.

19. The system of claim 16, wherein the AUC value is based at least on the reconstruction probability and a difference of a degree of abnormality between the encoder and a prior distribution about the set of latent values.

20. The system of claim 16, the computer-executable instructions when executed further causing the system to:
receive the normal data relating to network traffic observed in a normal state and the abnormal data relating to the network traffic observed in an abnormal state as the learning data for training the machine learning model for determining whether input data deviates from the normal state.

21. The system of claim 16, wherein the AUC value is an approximate AUC value based on a Heaviside step function, the approximate AUC value at least providing a marginal likelihood maximization for training the variational auto encoder based on unsupervised learning using the normal data.

22. The system of claim 16, the computer-executable instructions when executed further causing the system to:
receive a set of data for evaluating abnormality;
determine a degree of abnormality based on the received set of data, wherein the degree of abnormality is based on a combination of a reconstruction probability and a reconstruction error; and
determine a status, the status indicating whether the set of observed values indicates abnormality based on a predetermined threshold value.

23. A computer-readable non-transitory recording medium storing computer-executable instructions that when executed by a processor cause a computer system to:
determine, using an encoder, one or more latent values based on a set of observed values and a first parameter value, the set of observed values including normal data and abnormal data as a learning data set;
reconstruct, using a decoder, the set of observed value based on the determined one or more latent values and the second parameter value;
generate an area-under-the-receiver-operating-characteristic-curve (AUC) value based at least on a set of reconstructing probability of the abnormal data;
train, based on the generated AUC value, the first parameter and the second parameter of a machine learning model based on a variational auto encoder.

24. The computer-readable non-transitory recording medium of claim 23, the computer-executable instructions when executed further causing the system to:
receive the normal data based on sound of an object observed in a normal state and the abnormal data based on sound of the object observed in an abnormal state as the learning data for training the machine learning model for determining whether input data deviate from the normal state.

25. The computer-readable non-transitory recording medium of claim 23, wherein the variational auto encoder comprises the encoder and the decoder, and wherein the reconstructing probability of the abnormal data relates to a probability of reconstructing abnormal data based on the set of latent values.

26. The computer-readable non-transitory recording medium of claim 23, wherein the AUC value is based at least on the reconstruction probability and a difference of a degree of abnormality between the encoder and a prior distribution about the set of latent values.

27. The computer-readable non-transitory recording medium of claim 23, the computer-executable instructions when executed further causing the system to:
receive the normal data relating to network traffic observed in a normal state and the abnormal data relating to the network traffic observed in an abnormal state as the learning data for training the machine learning model for determining whether input data deviates from the normal state.

28. The computer-readable non-transitory recording medium of claim 23, wherein the AUC value is an approximate AUC value based on a Heaviside step function, the approximate AUC value at least providing a marginal likelihood maximization for training the variational auto encoder based on unsupervised learning using the normal data.
